(19) United States
(12) Patent Application Publication
(10) Pub. No.: US 2008/0235739 A1
(43) Pub. Date: Sep. 25, 2008

(54) System and Method For Remote Recording

(75) Inventor: Paulus Antonius Bonifatius Maria Coebergh Van Den Braak, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,576

(22) PCT Filed: Mar. 2, 2005
(86) PCT No.: PCT/IB05/50765

§ 371 Date: Sep. 5, 2006

(30) Foreign Application Priority Data
Mar. 10, 2004 (EP) 04100972.1

(51) Int. Cl. H04N 7/173

(52) U.S. Cl. 725/86

(57) ABSTRACT

The invention relates to a system and method for remote recording of content currently being reproduced on a content reproduction device (1). The content reproduction device (1) is capable of reproducing received content, has means for user input of a command to record the content currently being reproduced, is capable of determining a content attribute comprising at least one of: a content identifier identifying the content and a content channel identifier identifying a content channel on which the content is being transmitted, and is capable of transmitting a recording instruction comprising the content attribute to a remotely located recording device (3). The remotely located recording device is capable of receiving said recording instruction from said content reproduction device (1), identifying a transmission channel based on said content attribute, and recording said content received on said transmission channel.

### FIELD OF THE INVENTION

The invention relates to a system and method for remote recording of content, e.g. broadcast video (television) programming.

### BACKGROUND OF THE INVENTION

More and more television-enabled mobile devices, such as television-enabled mobile phones, are appearing on the market. A problem which is likely to be encountered by mobile users of such devices is that viewing of a program might have to be interrupted due to circumstances arising from the fact that the viewer is not stationary. For example, a viewer waiting in a traffic jam, waiting for a train or flight, an appointment or similar occasion might be watching an interesting program on a television-enabled mobile device, but then has to stop viewing before the program has ended.

Previously known patent publication EP 1 152 609 relates to a remote recording device which is linked to a reception module for receiving broadcast or cable television signals, such as a digital decoder. The remote recording device includes a hard disk for video and audio program storage capable of holding several hours of recording. The system offers remote programming of audio or video programs either via the Internet, or via a mobile telephone signal. Instructions to start a recording are formatted manually as an information message comprising the channel number of the channel to be recorded by the remote recording device and an indication of start and stop times or, alternatively, an indication that the recording should be initiated immediately.

Although this enables a user to record a program using the remote recording device, the remote recording device according to EP 1 152 609 has the drawback that the user must manually identify the program to be recorded, recall the corresponding channel number of the remote recording device and manually compose the information message comprising the channel number of the channel to be recorded by the remote recording device. Moreover, EP 1 152 609 does not enable the user to view a TV program, and therefore does not offer the user a way of determining whether an interesting TV program which he might want to record is being transmitted.

### OBJECT AND SUMMARY OF THE INVENTION

Taking the above into consideration, it is an object of the invention to provide a system which allows a user of a content reproduction device, e.g. a television-enabled mobile device, to automatically command a remote recording device, e.g. at home, to record content, e.g. a TV program, that the user is watching on his content reproduction device, without the hassle for the user how to select and ‘program’ the right channel, time, etc.—but ad-hoc/on impulse.

This object is achieved in that the system comprises a content reproduction device which is capable of reproducing received content, has means for user input of a command to record the content currently being reproduced, is capable of determining a content attribute comprising at least one of: a content identifier identifying the content and a content channel identifier identifying a content channel on which the content is being transmitted, and is capable of transmitting a recording instruction comprising the content attribute to a remotely located recording device; and a remotely located recording device which is capable of receiving said recording instruction from said content reproduction device, identifying a transmission channel based on said content attribute, and recording said content received on said transmission channel.

A content identifier may comprise, for example, a name, a description and/or a fingerprint of the content. The content reproduction device may be able to create a fingerprint through feature extraction and/or automatic feature recognition. The content reproduction device may be able to extract the name of the content and/or its description from an Electronic Program Guide (EPG). A content channel identifier may comprise, for example, the name, e.g. NBC, FOX, BBC and/or a logo of the content channel. A transmission channel may be identified, for example, by a frequency of an analog/digital terrestrial/satellite broadcaster or by a multicast group address. Content may be, for example, video (television) or audio (radio). A content reproduction device may be, for example, a television and/or radio-enabled mobile device.

It is a further object of the invention to provide a method of enabling a user of a content reproduction device to automatically command a remote recording device, e.g. at home, to record content, e.g. a TV program, that the user is watching on his device, without the hassle for the user how to select and ‘program’ the right channel, time, etc.—but ad-hoc/on impulse.

This object is achieved in that a method of allowing remote recording of content comprises the steps of: receiving a user-inputted command to record the content currently being reproduced on a content reproduction device, determining a content attribute comprising at least one of: a content identifier identifying the content and a content channel identifier identifying a content channel on which the content is being transmitted, and transmitting a recording instruction comprising the content attribute to a remotely located recording device; and a method of remote recording comprises the steps of: receiving a recording instruction comprising a content attribute, the content attribute comprising at least one of: a content identifier identifying content being reproduced on a content reproduction device and a content channel identifier identifying a content channel on which content reproduced on a content reproduction device is being transmitted, identifying a transmission channel based on said content attribute, and recording said content received on said transmission channel.

The method of allowing remote recording of content may be performed, for example, by a content reproduction device or an Internet service communicating with a content reproduction device. The method of recording content may be performed, for example, by a hard disk recorder, a DVD recorder, or a residential gateway commanding a hard disk recorder or DVD recorder.

Preferred embodiments are defined in the dependent claims.

### BRIEF DESCRIPTION OF THE DRAWINGS

In the drawings, wherein like reference characters denote similar elements throughout the several views:

FIG. 1 is a schematic view of a system for remote recording of broadcast video (television) programming currently viewed on a television-enabled mobile device according to the invention, and

FIG. 2 is a schematic view of a system according to FIG. 1, operated across two time zones.

Still other objects and features of the invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DESCRIPTION OF EMBODIMENTS

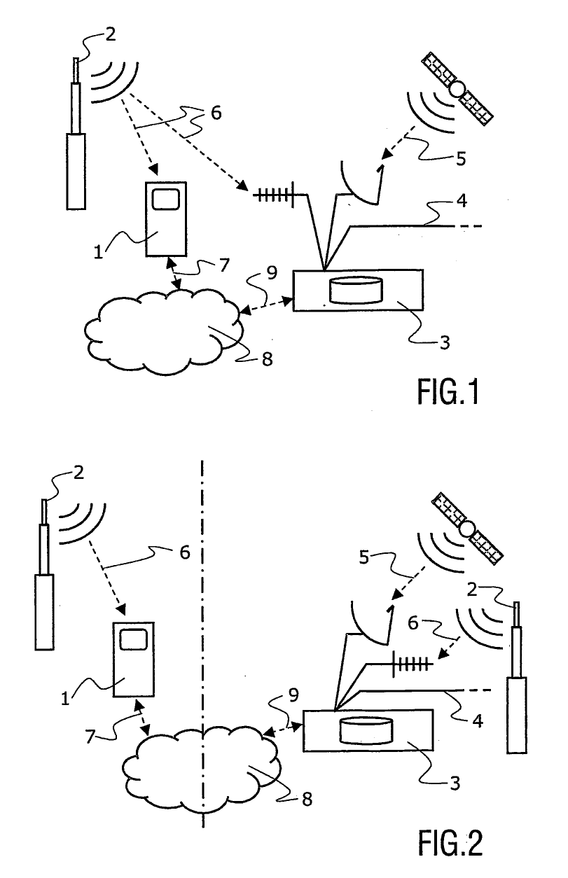

FIG. 1 illustrates schematically a system for remote recording of broadcast video (television) programming currently viewed on a display of a television-enabled mobile content reproduction device 1. The television-enabled mobile content reproduction device 1 may be e.g. a mobile phone, a communication-enabled PDA, a communication-enabled portable gaming device, or a similar device.

The television-enabled mobile content reproduction device 1 can be arranged for reception of broadcast video (television) programming transmitted, using either of a terrestrial analog or digital broadcasting standard, although it is envisaged that terrestrial digital broadcasting standards, such as DVB-T or ATSC, will usually provide better reception quality to the television-enabled mobile content reproduction device 1 as the user of the mobile content reproduction device 1 moves about, possibly between different broadcast transmitters 2.

It is an object of the invention to enable the user to automatically command a remote recording device 3, e.g. at home, to record a TV program that the user is watching on his mobile content reproduction device 1, without the hassle for the user how to select and ‘program’ the right channel, time, etc.—but ad-hoc/on impulse, as the recording device 3 at home may face a different set of channels than the mobile content reproduction device 1, often through a different source, e.g. cable 4, satellite 5 or terrestrial 6, and in a different order in the frequency spectrum. The recording device 3 at home may also be in a different time zone than the mobile content reproduction device 1, as illustrated in FIG. 2, and hence face a different arrangement of TV programs in the time/TV-channels space.

According to the invention, a first embodiment provides a system for remote recording of broadcast video (television) programming currently viewed on a television-enabled mobile content reproduction device 1. The television-enabled mobile content reproduction device 1 comprises communication means (illustrated by the arrows 7), such as a mobile phone module or a similar device, operating in accordance with any of current or future standards including: GSM, UMTS, etc. The communication means are arranged to communicate with a remotely located recording device 3 arranged for the reception of broadcast video (television) programming. This communication can take place either via a mobile phone network or combinations of a mobile phone network and either one of a fixed landline telephone network, a computer network, such as the Internet, or any other suitable current or future communication network 8. The recording device 3 may be any current or future recording device 3 including: a video cassette recorder (VCR), a digital video recorder (DVR) including a hard disk, a recordable digital versatile disc (DVD) or similar storage means, a digital television decoder including such recording means or a similar device. The television-enabled mobile content reproduction device 1 comprises means for, preferably automatically, identifying the programming currently viewed by its user, and further means for user input of a command to record the currently viewed programming. The television-enabled mobile content reproduction device 1 further comprises means for communicating the information identifying the currently viewed programming to the remote recording device 3, e.g. based on mobile phone technology. The remote recording device 3 comprises means for interpreting the information and converting it to an instruction for recording the corresponding programming, e.g. a micro-computer and associated software for carrying out the interpretation and conversion when executed on the micro-computer.

In a second embodiment of the invention, the means for identifying the programming currently viewed on the television-enabled mobile content reproduction device 1 is arranged to extract information regarding the currently viewed channel from teletext information embedded in the broadcast programming received by the television-enabled mobile content reproduction device 1. The information extracted from the teletext information embedded in the broadcast programming received by the television-enabled mobile content reproduction device 1 is preferably Program Delivery Control (PDC) information. Program Delivery Control is a generic name for systems in use in Europe providing vertical blanking interval (VBI) information-based programming for VCR timed recordings. However, several similar systems exist, the intention here being to encompass all similar systems within the scope of the expression Program Delivery Control information.

In a third embodiment, the means for identifying the programming currently viewed on the television-enabled mobile content reproduction device 1 is arranged to extract information regarding the currently viewed channel through feature extraction and automatic feature recognition in the programming received by the television-enabled mobile content reproduction device 1. One possibility is to arrange the means for identifying the currently viewed programming to identify the currently viewed channel through extracting and recognizing a channel logotype, if that feature is present in the signal which is being broadcast. However, it is envisaged that fingerprinting and corresponding recognition technology can be applied to other features of the video content, audio content or both.

In a fourth embodiment of the invention, the remote recording device 3 comprises communication means (illustrated by the arrows 9) arranged to reply to the information identifying the currently viewed programming on the television-enabled mobile content reproduction device 1 by communicating, to the television-enabled mobile content reproduction device 1, a sample picture of the programming currently received by the remote recording device 3. These communication means can also be arranged for communication either via a mobile phone network or combinations of a mobile phone network and either one of a fixed landline telephone network, a computer network, such as the Internet, or any other suitable current or future communication network 8. The television-enabled mobile content reproduction device 1 is arranged to display the sample picture on its display. The television-enabled mobile content reproduction device 1 further has means for user input, such as a keyboard, touch-screen or similar device, allowing input of a command for verifying or negating that the program identified by the sample picture is the programming to be recorded and for communicating this information to the remote recording device 3. The remote recording device 3 further comprises means for interpreting verifying information as an instruction for recording the programming currently received by the remote recording device 3, or interpreting negating information as an instruction for tuning the remote recording device 3 to a different channel and repeating the step of communicating, to the television-enabled mobile content reproduction device 1, a sample picture of the programming now received, until a verifying reply is received from the user of the television-enabled mobile content reproduction device 1, whereupon recording is initiated.

In a fifth embodiment, the means for identifying the programming currently viewed on the television-enabled mobile content reproduction device 1 is arranged to extract information regarding the currently viewed channel from information embedded in a digital transport stream (TS) comprising the broadcast programming received by the television-enabled mobile content reproduction device 1.

In accordance with one digital broadcasting standard, DVB, given as a non-limiting example, multiple radio frequency (RF) channels for broadcasting can be used by a single ‘network’. In one RF channel, one Transport Stream (TS) can be broadcast. In one TS, multiple ‘Services’ are multiplexed together with a data stream. Each Service corresponds to a single ‘TV channel’. The data stream carries all information on all Services in the Transport Stream, in the form of ‘objects’ (tables with information items). Consequently, in the case of digital reception, both the mobile content reproduction device 1 and the recording device 3 at home can find, access and use this information, regardless of time shifts or the way in which they are ‘connected’ (cable/satellite/terrestrial, allocation of RF channels). Of course, there may also be multiple ‘networks’, each with one or more transport streams.

The following information items usually exist in the data stream and can be suitably used for implementing the invention:
1. A Digital Video Broadcast Locator=DVB Locator, which can be used to identify and find the Service in the TS.
2. An Original Network ID, which uniquely identifies the broadcast network.
3. A Transport Stream ID, which identifies the TS uniquely within one network.
4. A Service ID, which identifies the Service uniquely within one TS.
5. Logical Channel Numbers=LCN, which is the suggested order of channels as predefined by the network, and can be used for automatic installation of the channels in any piece of video equipment.
6. An Electronic Service Guide=ESG and an Electronic Program Guide EPG.
   These guides contain ‘event information’ (in Event Information Tables=EIT) for a certain period into the future. An event here marks the planned start or end of a program. An event in the past is purged from this table once the program in question has terminated, i.e. only the most recent event is still kept.

In a case where both the television-enabled mobile content reproduction device 1 and the remote recording device 3 receive digital broadcasts in one and the same time zone, the information extracted from the transport stream preferably comprises an original network identifier, a transport stream identifier and a service identifier. In most cases, this information should suffice for enabling the remote recording device 3 to interpret this information and convert it to an instruction for recording the program corresponding to the program currently viewed by the user of the mobile content reproduction device 1.

In the case where the devices operate in different time zones, as illustrated in FIG. 2, or possibly where a specific program is retransmitted at a later time, e.g. at a +1 h channel, such as is available in certain networks, the information extracted from the transport stream further comprises electronic service guide (ESG) data and/or electronic program guide (EPG) data. In most cases, this information should suffice for enabling the remote recording device 3 to interpret this information and convert it to an instruction for scheduled later recording of a program corresponding to the program currently viewed by the user of the mobile content reproduction device 1. In FIG. 2, the television-enabled mobile content reproduction device 1 is operated in a first time zone, on the left-hand side of the dashed/dotted line, and the remote recording device 3 is operated in a second time zone, different from the first, on the right-hand side of the dashed/dotted line.

While fundamental novel features of the invention as applied to a preferred embodiment thereof have been shown, described and pointed out, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

‘Computer program product’ is to be understood to mean any software product stored on a computer-readable medium, such as a floppy disk, downloadable via a network, such as the Internet, or marketable in any other manner.

1. A system for remote recording of content, comprising:
a content reproduction device (1) which is capable of reproducing received content, has means for user input of a command to record the content currently being reproduced, is capable of determining a content attribute comprising at least one of: a content identifier identifying the content and a content channel identifier identifying a content channel on which the content is being transmitted, and is capable of transmitting a recording instruction comprising the content attribute to a remotely located recording device (3); and
a remotely located recording device (3) which is capable of receiving said recording instruction from said content reproduction device (1), identifying a transmission channel based on said content attribute, and recording said content received on said transmission channel.

2. A content reproduction device for use in the system of claim 1.

3. The content reproduction device of claim 2, further capable of receiving and reproducing a sample of content currently being received by said remotely recording device (3) on said transmission channel, having means for user input of a further command for verifying or negating that said sample represents the content to be recorded, and further capable of communicating said further command to said remotely located recording device (3).

4. The content reproduction device of claim 2, characterized by being a television-enabled mobile device upon which current viewing of said broadcast video programming to be recorded can be effected, said television-enabled mobile device comprising communication means, said communication means being arranged to communicate with the remotely located recording device (3), said television-enabled mobile device further comprising means for identifying the currently viewed programming, said television-enabled mobile device further having means for user input of a command to record the currently viewed programming, and said television-enabled mobile device further comprising means for using said communication means communicating said information identifying said currently viewed programming to said remotely located recording device (3).

5. The content reproduction device of claim 4, characterized in that said means for identifying the currently viewed programming is arranged to extract information regarding the currently viewed channel from teletext information embedded in said broadcast programming received by said television-enabled mobile device.

6. The content reproduction device of claim 4, characterized in that said means for identifying the currently viewed programming is arranged to extract information regarding the currently viewed channel through feature extraction and automatic feature recognition in said programming received by said television-enabled mobile device.

7. The content reproduction device of claim 4, characterized in that said means for identifying the currently viewed programming is arranged to identify said currently viewed channel through extracting and recognizing a channel logotype.

8. The content reproduction device of claim 4, characterized in that said means for identifying the currently viewed programming is arranged to extract information regarding the currently viewed channel from information embedded in a digital transport stream comprising said broadcast programming received by said television-enabled mobile device.

9. The content reproduction device of claim 8, characterized in that said information extracted from said transport stream further comprises electronic service guide data and/or electronic program guide data.

10. A computer program product enabling, upon its execution, a programmable device to function as the content reproduction device (1) of claim 1.

11. A remotely located recording device for use in the system of claim 1.

12. The remotely located recording device of claim 11, further capable of replying to said recording instruction by communicating, to said content reproduction device (1), a sample of content currently being received by said remotely recording device (3) on said transmission channel.

13. The remotely located recording device of claim 11, further capable of delaying said recording until a verifying command has been received.

14. The remotely located recording device of claim 12, further capable of selecting a different transmission channel when a negative command is received.

15. The remotely located recording device of claim 11, being arranged for the reception of broadcast video programming and comprising means for interpreting said information and converting it to an instruction for recording a corresponding programming.

16. A computer program product enabling, upon its execution, a programmable device to function as the remotely located recording device (3) of claim 1.

17. A method of enabling remote recording of content, comprising the steps of:
receiving a user-inputted command to record the content currently being reproduced on a content reproduction device (1);
determining a content attribute comprising at least one of: a content identifier identifying the content and a content channel identifier identifying a content channel on which the content is being transmitted; and
transmitting a recording instruction comprising the content attribute to a remotely located recording device (3).

18. A method of remote recording of content, comprising the steps of: receiving a recording instruction comprising a content attribute, the content attribute comprising at least one of: a content identifier identifying content being reproduced on a content reproduction device (1) and a content channel identifier identifying a content channel on which content reproduced on a content reproduction device (1) is being transmitted;
identifying a transmission channel based on said content attribute; and
recording said content received on said transmission channel.
